(19) United States
(12) Patent Application Publication
(10) Pub. No.: US 2022/0017699 A1
(43) Pub. Date: Jan. 20, 2022

(54) MOLECULAR SPACE FILLER FOR BINDER JET INK

(71) Applicant: Applied Materials, Inc., Santa Clara, CA (US)

(72) Inventors: Yingdong Luo, San Jose, CA (US); Sivapackia Ganapathiappan, Los Altos, CA (US); Daihua Zhang, Los Altos, CA (US); Hou T. Ng, Campbell, CA (US); Nag B. Patibandla, Pleasanton, CA (US)

(21) Appl. No.: 16/933,848

(22) Filed: Jul. 20, 2020

(51) Int. Cl. C08G 77/04; C09D 183/08; C08F 220/18; C08L 33/12; B29C 64/153; B29C 64/35; B29C 64/357; B29C 64/314

(52) U.S. Cl. CPC C08G 77/045; C09D 183/08; C08F 220/18; C08L 33/12; B33Y 10/00; B29C 64/35; B29C 64/357; B29C 64/314; B29C 64/153

(57) ABSTRACT

An implementation described herein provides a binder ink mixture for 3D printing of ceramic parts in a binder jet process. The binder ink mixture includes a molecular space filler and a free radical initiator.

### TECHNICAL FIELD

This disclosure relates to improving the green part density in binder jet printing of three-dimensional parts.

### BACKGROUND

Among various methods of additive manufacturing, binder jet printing has advantages for three dimensional (3D) printing of ceramic parts. There are two parts used in a binder jet printing process. These include ceramic beads, which constitute the bulk volume of the final part. The other part is an organic binder jet ink which binds the beads together to form the green part. In the printing process, the binder ink is cured to hold the beads together to form the green part.

The beads that are not held in place by the cured binder are retrieved after printing, during a cleaning process. To remove the organic binder between the beads of the green part, the green part is sintered at high temperatures, for example, between about 300° C. and 600° C. After the organic binder is removed, the final part may be formed by firing the part, for example, at around 900° C. or higher. As used herein, the term sintering will include both the sintering and firing processes.

### SUMMARY

In implementations described herein, molecular space fillers are used to form part of the binder for binder jet printing. During sintering, the molecular space fillers form ceramic materials that occupies part of the space between the ceramic beads that was occupied by the binder. This reduces the shrinkage of the parts, and facilitates the development of more complex parts.

An implementation described herein provides a binder ink mixture for 3D printing of ceramic parts in a binder jet process. The binder ink mixture includes a molecular space filler and a free radical initiator.

Another implementation described herein provides a method for making a binder ink mixture for forming ceramic parts in binder jet printing, including forming a blend of a molecular space filler and a free radical initiator.

Another implementation described herein provides a method of manufacturing a three-dimensional (3D) ceramic part using a binder ink mixture comprising a molecular space filler. The method includes obtaining a binder ink mixture comprising a molecular space filler, and printing a green part. Printing the green part includes printing a layer of the green part by forming a layer of ceramic beads in a binder jet printer, printing a pattern of the binder ink mixture on the layer of ceramic beads, and curing the binder ink mixture to bind the ceramic beads in the pattern in place. The printing of layers of the green part is repeated until the green part is completed. The green part is sintered to remove organic components of the binder ink mixture and fuse the ceramic beads to form the 3D ceramic part.

The details of one or more implementations are set forth in the accompanying drawings and the description below. Other features and advantages will be apparent from the description and drawings, and from the claims.

### BRIEF DESCRIPTION OF DRAWINGS

FIG. 1 is a schematic drawing of the three dimensional printing of a green part using a binder jet printing process;

FIG. 2A is a schematic diagram of the sintering of a green part formed by a binder jet printing process.

FIG. 2B is a schematic diagram of the sintering of a green part that has been printed using a binder jet ink that includes a molecular space filler.

FIG. 3 is a process flow diagram of a method for forming a binder jet printed part using a molecular space filler.

FIG. 4 is a plot of the thermogravimetric analysis (TGA) of the cured experimental ink 1 (EI 1).

FIG. 5 is a schematic drawing of the decomposition of a polyhedral oligomeric silsesquioxane that is substituted with eight n-propyl acrylate groups (POSS-Ac₈) to form silica during sintering.

FIG. 6 is a plot of the TGA of the cured experimental ink 2 (EI 2).

FIG. 7 is a plot of the TGA of the cured experimental ink 3 (EI 3).

FIG. 8 is a schematic drawing of the decomposition of a polydimethylsiloxane (PDMS), which has been randomly substituted with 17.5 mol. % n-propyl acrylate groups (PDMS-Ac), to form silica during sintering.

FIG. 9 is a plot of the TGA of the cured experimental ink 4 (EI 4).

Like reference symbols in the various drawings indicate like elements.

### DETAILED DESCRIPTION

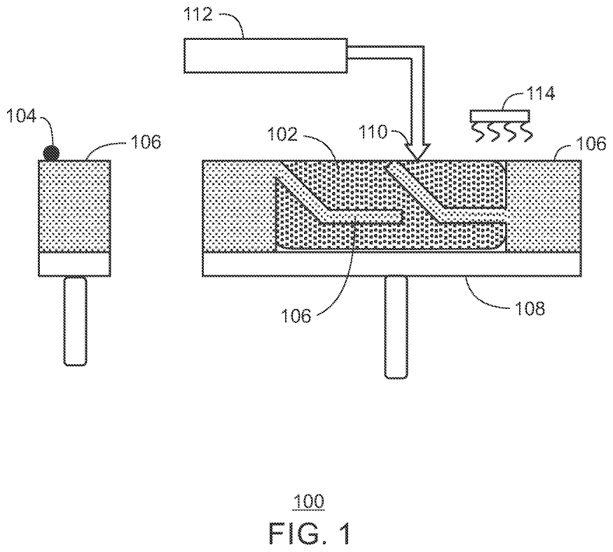

FIG. 1 is a schematic drawing 100 of the three dimensional printing of a green part 102 using a binder jet printing process. In the binder jet printing process, a dispenser delivers a layer of ceramic beads 106 over a platform 108 in a build chamber (not shown). For example, beads could be pushed by a blade or roller 104 from a reservoir adjacent the platform 108 or the beads could be delivered from an opening in a hopper that moves laterally across the platform.

A printhead 110 is used to print a pattern of a binder jet ink 112 over the layer of ceramic beads 106. In implementations described herein, the binder jet ink 112 includes a molecular space filler, which is a compound that decomposes to form a ceramic, filling empty space left between the ceramic beads 106 when the binder jet ink 112 is decomposed during sintering. In some implementations, as the printhead 110 creates the pattern, a radiation source 114 is used to initiate polymerization of the binder ink, such as with a UV light source activating a photoinitiator or an infrared source activating a thermal initiator.

As each layer is printed, the platform 108 is lowered, and a new layer of ceramic beads 106 is spread over the top of the platform 108 and green part 102 by the roller 104. The printhead 110 then prints a new pattern of binder jet ink 112. In some implementations, the new pattern is fixed by radiation from the radiation source 114, before the platform 108 is lowered for another layer. Completion of the binder jet printing process produces the final green part 102, which includes the binder jet ink 112 holding the ceramic beads 106 together.

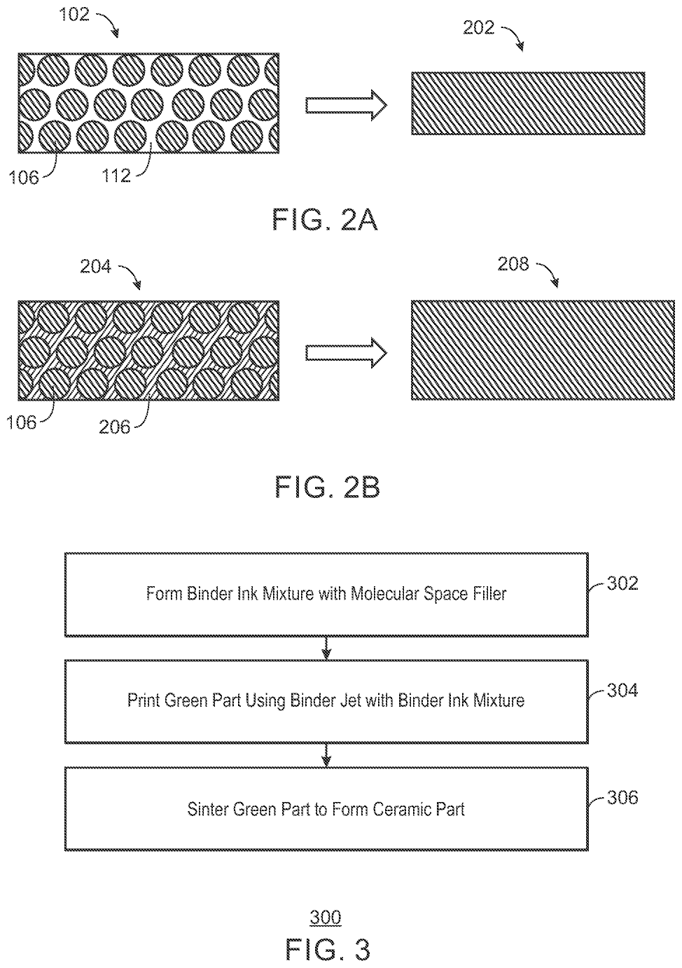

FIG. 2A is a schematic diagram of the sintering of a green part 102 formed by a binder jet printing process. Like numbered items are as described with respect to FIG. 1. During the sintering, the binder jet ink 112 of the green part 102 will decompose to gases and diffuse out of the structure as the green part 102 is heated to a first temperature. This leaves empty spaces in between the ceramic beads 106 of the part. During a higher temperature firing or sintering process, or as the temperature continues to rise in the firing process, the empty spaces are filled by nearby ceramic beads 106, causing shrinkage during the formation of the final part 202. A linear shrinkage of 20 to 50% in each dimension is common. This can cause significant problems in a manufacturing process, and significant modeling work is necessary for successful printing.

In addition to accounting for the shrinkage, the green part 102 should hold its shape during sintering. Accordingly, support of the ceramic beads 106 is needed to avoid the collapse of the structure. The presence of a slow decomposing polymer, for example, including a space filler that forms a ceramic during sintering, may help to maintain the accuracy of the part dimensions during sintering and firing.

FIG. 2B is a schematic diagram of the sintering of a green part 204 that has been printed using a binder jet ink 206 that includes a molecular space filler. As used herein, the term “molecular space filler” indicates that the size of the material is at the molecular level, and that the material fills the voids that are formed during the sintering. Accordingly the material is consistent with an ink-jetting process. Generally, the jetting process will be driven by piezoelectric ink jets, although thermal ink jetting may be used in some embodiments.

The molecular space filler is an inorganic component that is converted during sintering to a material that is the same or compatible with the material of the ceramic beads 106, efficiently filling the space, or voids, between the ceramic beads 106. As a result, the sintered part 208 may have much less shrinkage from the green part 204.

FIG. 3 is a process flow diagram of a method 300 for forming a binder jet printed part using a molecular space filler. The method begins at block 302 with the formation of a binder ink mixture that includes the molecular space filler. As described herein, the molecular space filler may include any number compounds that convert to an inorganic matrix during sintering. For example, the molecular space filler may include a substituted polyhedral oligomeric silsesquioxane (POSS), of which several types are available from Hybrid Plastics, Inc. Other materials that may be used in implementations include acrylated silanes, substituted polydimethylsiloxane, such as acrylated polydimethylsiloxane, 3-(trimethoxysilyl)propyl (meth)acrylate, trimethoxyvinylsilane, triethoxyvinylsilane, and allyltrimethylsilane, among others. It may be noted that combinations of these materials may be used. The molecular space fillers may be used directly as the binder ink or may be blended with monomers or other oligomers to adjust the viscosity.

The inorganic component of the binder is not limited to a molecular space filler. In some implementations, the molecular space filler is used in concert with a nanoparticle space filler. The nanoparticle space filler includes ceramic particles having a size of less than about 500 nm, less than about 250 nm, or less than about 100 nm, allowing the nanoparticle space filler to be blended with the binder ink mixture for jetting. The ceramic particles may include fumed silica, titania, alumina, silicon carbide, silicon nitride carbide, or silicon nitride, among others. In an implementation, the nanoparticle space filler is silica, as described with respect to Example 1, below.

In implementations described in examples herein, the molecular space filler is a polyhedral oligomeric silsesquioxane that is substituted with eight n-propyl acrylate groups, termed “POSS-Ac₈”. In another implementation described herein, the molecular space filler is a polydimethylsiloxane (PDMS) that is randomly substituted with about 17.5 mol. % n-propyl acrylate groups, providing a material termed “PDMS-Ac”, herein. For both of these molecular space fillers, the n-propyl acrylate groups provide sterically unhindered double bonds that can participate in the polymerization reaction. Further, both of these oligomers function as cross-linking agents during the polymerization process.

The binder ink mixture also includes a free radical initiator. In some implementations, the free radical initiator is a photoinitiator, such as Omnirad 819, available from IGN resins, to initiate a free radical polymerization upon irradiation, for example, with UV-A, UV-B, or UV-C, or any combinations thereof. In other implementations, the final binder ink mixture may include a thermal initiator, such as an azo compound or a peroxide, to initiate a free radical polymerization upon exposure to elevated temperatures, for example, from heating elements.

At block 304, the green part is printed using binder jet technology. To print the green part, a layer of ceramic beads are dispensed over a build plate. The binder ink is deposited selectively over the layer of beads, for example, by inkjet printing, to form patterns in the x-y plane. The printed beads are then exposed to light or heat energy, which polymerizes, or cures, the binder ink, holding the beads that have been printed with binder ink in place. The beads that have no binder ink are not held in place, but remain as supports for the structure during formation. Another layer of beads is spread over the first layer, and a fresh amount of the binder ink is sprayed and cured to extend the patterns in the z direction. By repeating this process layer by layer, a green part having a three-dimensional structure of ceramic beads held together by the cured binder is generated. Once the green part is finished, it is removed from the printer, and loose ceramic beads are recovered for reuse. The green part may be carefully cleaned to prepare for sintering.

At block 306, the green part is sintered. As described herein, the sintering may include a stepped heating cycle in which the organic components of the binder are removed at a lower temperature, and the beads are fully fused at a higher temperature. For example, the green part can be subjected to the lower temperature for an initial period of 1 minute to 24 hours, and then subjected to the higher temperature for a subsequent period of 1 hour to 48 hours. In some implementations, the lower temperature is between 300° C. and 800° C. In some implementations, the higher temperature is about 800° C. or higher.

Using the molecular space filler, the two temperature stepped heating cycle may not be used, as the amount of organics to be removed during sintering of the binder ink mixture described herein is lower. Accordingly, in some implementations, the temperature is directly ramped to the maximum temperature, such as 1000° C., over a period of time, such as 12 hours.

### EXAMPLES

The examples are given only as examples and not meant to limit the present techniques. Four experimental ink formulations were tested using different formulations. In the descriptions below, these are designated as experimental ink (EI) 1, EI 2, EI 3, and EI 4. EI 1 included a nanoparticle space filler, while EI 2, EI 3, and EI 4 all included a molecular space filler.

### Example 1: Binder Ink Formulation Including Silica Nanoparticles (EI 1)

An initial test was run on an ink formulation that included silica nanoparticles, termed EI 1. The formulation of the EI 1 is shown in Table 1, which includes 1,6-hexanediol diacrylate (HDDA), silica nanoparticles (20 nm, d=2.65), and Omnirad 819 as the photoinitiator.

TABLE 1
EI 1 formulation including silica nanoparticles.

| Components | Wt. % | Vol. % |
|---|---|---|
| HDDA | 49 | 73 |
| Silica nanoparticles | 49 | 27 |
| Omnirad 819¹ | 2 | |

¹Available from IGM Resins of Charlotte, NC, USA

In Table 2, the physical properties of the EI 1 after curing are compared to a binder ink based on an acrylate monomer. The results show that the EI 1 has an acceptable viscosity for jetting, e.g., less than 20 cP at 70° C., and higher modulus than the commercial binder ink.

TABLE 2
Comparison of physical properties of EI 1 to F1042 after curing.

| | Viscosity @ | Viscosity @ | E30 | E90 |
|---|---|---|---|---|
| | RT | 70° C. | Modulus | Modulus |
| | (cP) | (cP) | (MPa) | (MPa) |
| EI 1 | 120 | 19 | 3130 | 1990 |
| F1042 | ~100 | 14 | 1300 | 50 |

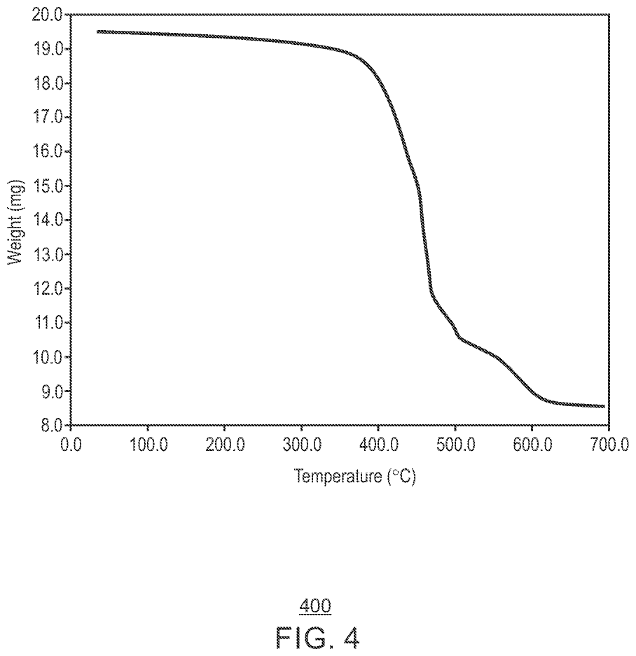

FIG. 4 is a plot of the thermogravimetric analysis (TGA) 400 of the cured EI 1. The temperature ramping in the TGA simulates the decomposition of the material during sintering. As can be seen in the TGA 400, the cured EI 1 starts to lose weight around 100° C. The rate of the weight loss substantially increases at about 350° C., and levels off after the temperature increases beyond about 600° C. The amount of material remaining indicates the amount that would be left between beads in a green part after sintering. In this example, the actual residue was 46 wt. % of the initial material used, which is the amount of empty space in the sintered green part that would be replaced with the silica nanoparticles.

### Example 2: Binder Ink Formulation Including POSS-Ac₈ in N,N-Diethyl Acrylamide (EI 2)

Another ink formula tested, EI 2, included POSS-Ac₈ or polyhedral oligomeric silsesquioxane that is substituted with eight n-propyl acrylate groups as described herein. The formulation of the EI 2, as shown in Table 3, includes the POSS-Ac₈, N,N-diethylacrylamide (DEAA), and Omnirad 819, as the photoinitiator.

TABLE 3
Binder ink formulation for EI 2.

| Components | Wt. % |
|---|---|
| POSS-Ac₈ | 66 |
| DEAA | 32 |
| Omnirad 819 | 2 |

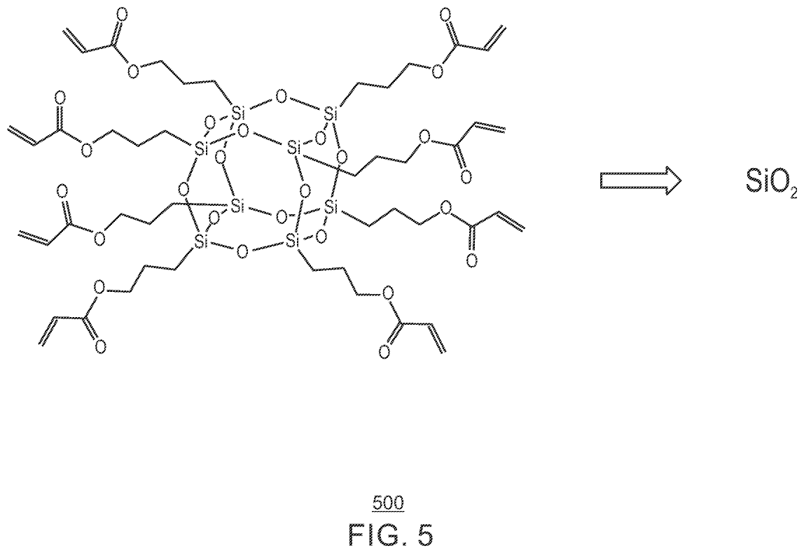

FIG. 5 is a schematic drawing 500 of the POSS-Ac₈ to form silica during sintering. During the sintering, the organic material forming the polymeric structure of the binder is decomposed, and the silicon oxide backbone is left behind. The silica may be bonded with other POSS moieties, with the ceramic of the beads, or both, during the process, forming a uniform matrix.

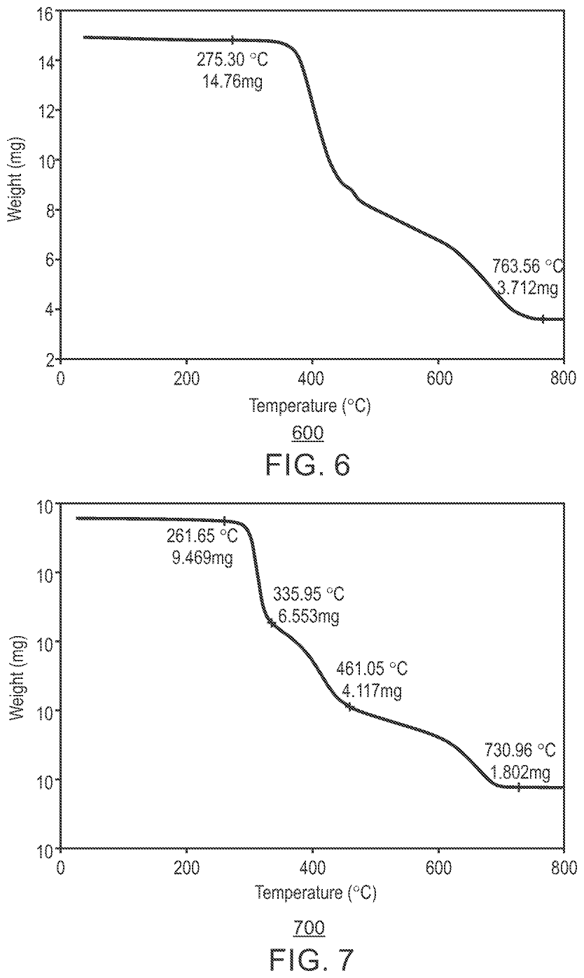

FIG. 6 is a plot of the TGA 600 of the cured EI 2. As described for FIG. 4, the temperature ramping in the TGA simulates the decomposition of the material during sintering. As can be seen in the TGA 600, the cured EI 2 starts to lose weight around 100° C., however, at a very slow rate. The rate of the weight loss substantially increases at about 350° C., and levels off after the temperature increases beyond about 700° C. As for the TGA 400 of EI 1, the amount of material remaining indicates the amount that would be left between beads in a green part after sintering. In this example, the actual residue was 25 wt. % of the initial material used, which is the amount of empty space in the sintered green part that could be replaced with the silica structure formed from the POSS-Ac₈.

### Example 3: Binder Ink Formulation Including POSS-Ac₈ in Isobornyl Acrylate (IBXA) (EI 3)

The formulation of the EI 3, as shown in Table 4, includes the POSS-Ac₈, IBXA, and Omnirad 819 as the photoinitiator.

TABLE 4
Binder ink formulation for EI 4.

| Components | Wt. % |
|---|---|
| POSS-Ac₈ | 49 |
| IBXA | 49 |
| Omnirad 819 | 2 |

FIG. 7 is a plot of the TGA 700 of the cured EI 3. As described for FIG. 4, the temperature ramping in the TGA simulates the decomposition of the material during sintering. As can be seen in the TGA 700, the cured EI 2 starts to lose weight around 100° C., however, at a very slow rate. The rate of the weight loss substantially increases at about 300° C., and levels off after the temperature increases beyond about 700° C. As for the previous TGAs, multiple decomposition peaks are seen. In this TGA 700, the additional decomposition peaks, starting at 335.95° C. and 461.05° C. are labeled. However, as for the previous TGAs, the amount of material remaining is a more important measurement, as that indicates the amount that would be left between beads in a green part after sintering. In this example, the actual residue was 19 wt. %, of the initial material used, which is the amount of empty space in the sintered green part that could be replaced with the silica structure formed from the POSS.

### Example 4: Binder Ink Formulation Including Acrylate Functionalized Polydimethylsilicone (PDMS-Ac) (EI 4)

Another ink formula tested, EI 4, included PDMS-Ac, in which 82.5% of the —Si—O— backbone units are substituted with two methyl groups, and 17.5% of the —Si—O— backbone units are substituted with one methyl group and one n-propyl acrylate group. The formulation of the EI 4, as shown in Table 5, includes the PDMS-Ac and Omnirad 819 as the photoinitiator. In contrast with the previous test formulations, no further monomers were added to the mixture.

TABLE 4
Binder ink formulation for EI 4.

| Components | Wt. % |
|---|---|
| PDMS-Ac | 98 |
| Omnirad 4265¹ | 2 |

¹Available from IGM Resins of Charlotte, NC, USA.

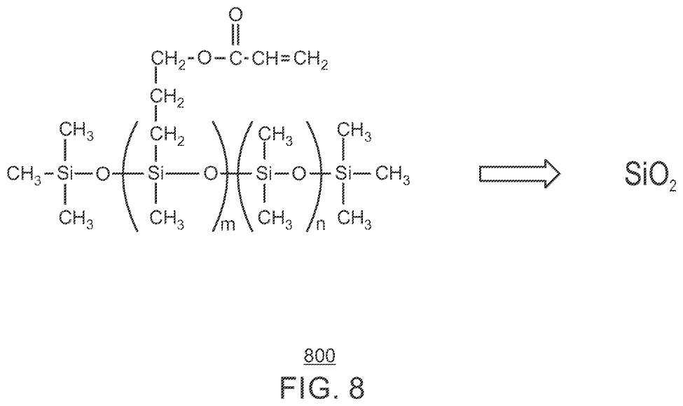

FIG. 8 is a schematic drawing 800 of the decomposition of a polydimethylsiloxane (PDMS) that has been randomly substituted with 17.5 mol. % n-propyl acrylate groups (PDMS-Ac) (m), to form silica during sintering. During the sintering, the organic material forming the polymeric structure of the binder is decomposed, and the silicon oxide backbone is left behind. The silica may be bonded with the ceramic of the beads during the process, forming a uniform matrix. In the case of the PDMS-Ac, a portion of the siloxane backbone is decomposed during the sintering, as described with respect to Table 6.

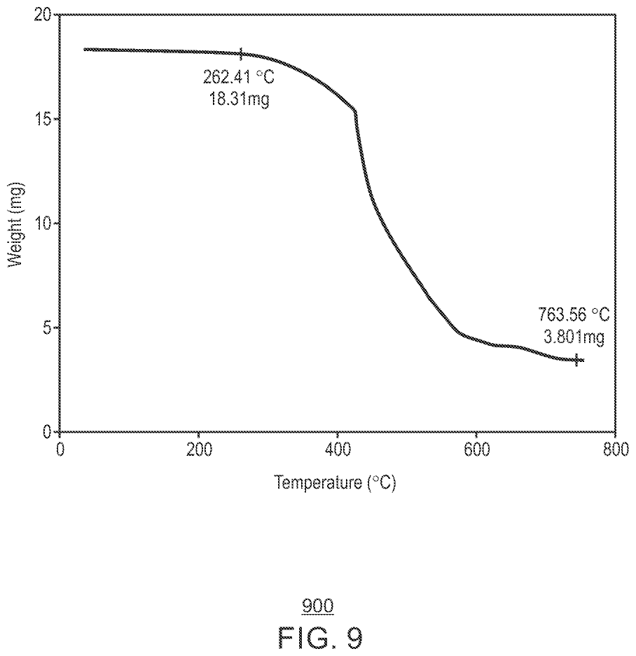

FIG. 9 is a plot of the TGA 900 of the cured EI 4. As described for FIG. 4, the temperature ramping in the TGA simulates the decomposition of the material during sintering. As can be seen in the TGA 900, the cured EI 2 starts to lose weight around 200° C., until a sharp transition at about 450° C. after which the decomposition proceeds quickly. The decomposition levels off after the temperature increases beyond about 700° C. The amount of material remaining is a more important measurement, as that indicates the amount that would be left between beads in a green part after sintering. In this example, the actual residue was 21 wt. %, of the initial material used, which is the amount of empty space in the sintered green part that could be replaced with the silica structure formed from the PDMS.

The results, including physical properties, of all five formulations tested, EI 1, EI 2, EI 3, EI 4, and F1042, are shown in Table 6. As described herein, the F1042 is the control against which the properties of the experimental inks were measured.

TABLE 6
Comparison of space filling inks for binder jet printing.

| | | | | | | TGA residue % |
|---|---|---|---|---|---|---|
| | | ‘Particle’ | Diluent/PI | Viscosity @ | E 30/E 90 | at 800° C. |
| Ink | ‘Particle’ | wt. % | (@ 2 wt. %) | 70° C. | (MPa) | (theo./meas.) |
| EI 1 | SiO2 | 50 | HDDA/819 | 19 | 3130/1900 | 50%/46%¹ |
| | (20 nm) | | | | | |
| EI 2 | POSS-Ac₈ | 67 | DEAA/819 | 16 | 1792/1227 | 24%/25%² |
| EI 3 | POSS-Ac₈ | 50 | IBXA/819 | 15 | 2091/1633 | 18%/19%² |
| EI 4 | PDMS-Ac | N/A | Pure/4265⁶ | N/A⁴ | N/A⁵ | 77%/21%³ |

| | | | | |
|---|---|---|---|---|
| F1042 | N/A | 14 | 1300/50 | Est. 0% |

¹EI 1 yielded the highest filling formulation.
²The POSS-Ac₈ was closest to mass balance, indicating no vaporization of Si components.
³The PDMS vaporizes to a certain extent due to breaking of organic links during decomposition.
⁴The viscosity is about 20 cP at 70° C., but is tunable.
⁵The modulus of the cured binder based on PDMS-Ac was too low to measure.
⁶A different photoinitiator was used for the PDMS-Ac, Omnirad 4265, available from IGM Resins.

As can be seen from the examples above, incorporation of materials that produce ceramic oxides into the binder ink formulation can lower the amount of free space between beads, increasing the density of the green parts and decreasing the amount of shrinkage during sintering. Further, the materials also help to prevent the collapse of the three-part structure during sintering, as the decomposition of the cured formulations that include inorganic materials take place at higher temperatures, for example, up to about 600° C., while pure organic binders decompose at lower temperatures, for example, less than about 450° C. The addition of metal oxide nanoparticles, such as the fumed silica particles described herein, also further increases the filling of void space in the green parts, further decreasing the amount of shrinkage during sintering. As a result, less modeling may be needed and more complex parts may be produced.

In implementations described herein, molecular space fillers are used to form part of the binder for binder jet printing. During sintering, the molecular space fillers form ceramic materials that occupies part of the space between the ceramic beads that was occupied by the binder. This reduces the shrinkage of the parts, and facilitates the development of more complex parts.

An implementation described herein provides a binder ink mixture for 3D printing of ceramic parts in a binder jet process. The binder ink mixture includes a molecular space filler and a free radical initiator.

In an aspect, the molecular space filler includes a substituted polyhedral oligomeric silsesquioxane (POSS). In an aspect, the substituted polyhedral oligomeric silsesquioxane is substituted with 8 n-propyl acrylate groups (POSS-Ac8), with a formula:

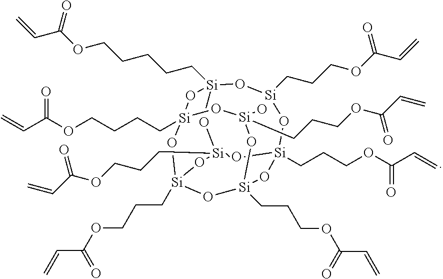 [SMILES: C=CC(=O)OCCCCC[Si]12O[Si]3(CCCCOC(=O)C=C)O[Si]4(CCCOC(=O)C=C)O[Si](CCCOC(=O)C=C)(O1)O[Si]1(CCCOC(=O)C=C)O[Si](CCCOC(=O)C=C)(O2)O[Si](CCCOC(=O)C=C)(O3)O[Si](CCCOC(=O)C=C)(O4)O1]

In an aspect, the molecular space filler comprises a substituted polydimethylsiloxane. In an aspect, the substituted polydimethylsiloxane comprises a polymer of formula:

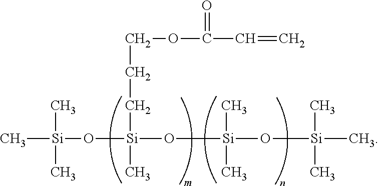

In an aspect, m is between about 15 and about 20, and wherein the sum of m and n is 100.

In an aspect, the binder ink mixture further includes a monomer. In an aspect, the monomer includes 1,6-hexanediol diacrylate (HDDA). In an aspect, the monomer includes N,N-diethylacrylamide (DEAA). In an aspect, the monomer includes isobornyl acrylate (IBXA).

In an aspect, the free radical initiator is a photoinitiator. In an aspect, the free radical initiator is a thermal initiator.

In an aspect, the binder ink mixture includes nanoparticles. In an aspect, the nanoparticles comprise silica.

Another implementation described herein provides a method for making a binder ink mixture for forming ceramic parts in binder jet printing, including forming a blend of a molecular space filler and a free radical initiator.

In an aspect, the molecular space filler comprises a substituted polyhedral oligomeric silsesquioxane (POSS), or a substituted polydimethylsiloxane, or both. In an aspect, the free radical initiator is a photoinitiator, or a thermal initiator, or both.

In an aspect, the method includes blending a monomer into the binder ink mixture. In an aspect, the monomer comprises 1,6-hexanediol diacrylate (HDDA), N,N-diethylacrylamide (DEAA), or isobornyl acrylate (IBXA), or both.

In an aspect, the method includes blending nanoparticles into the binder ink mixture. In an aspect, the nanoparticles comprise silica.

Another implementation described herein provides a method of manufacturing a three-dimensional (3D) ceramic part using a binder ink mixture comprising a molecular space filler. The method includes obtaining a binder ink mixture comprising a molecular space filler, and printing a green part. Printing the green part includes printing a layer of the green part by forming a layer of ceramic beads in a binder jet printer, printing a pattern of the binder ink mixture on the layer of ceramic beads, and curing the binder ink mixture to bind the ceramic beads in the pattern in place. The printing of layers of the green part is repeated until the green part is completed. The green part is sintered to remove organic components of the binder ink mixture and fuse the ceramic beads to form the 3D ceramic part.

In an aspect, the method includes cleaning the green part prior to sintering to remove loose ceramic beads. In an aspect, the method includes recycling loose ceramic beads to the binder jet printer.

In an aspect, obtaining the binder ink mixture includes forming a blend of the molecular space filler and a free radical initiator. In an aspect, the molecular space filler includes a substituted polyhedral oligomeric silsesquioxane (POSS), or a substituted polydimethylsiloxane, or both. In an aspect, the free radical initiator is a photoinitiator, or a thermal initiator, or both.

In an aspect, the method includes blending a monomer into the binder ink mixture. In an aspect, the monomer includes 1,6-hexanediol diacrylate (HDDA), N,N-diethylacrylamide (DEAA), or isobornyl acrylate (IBXA), or both.

In an aspect, the method includes blending nanoparticles into the blend. In an aspect, the nanoparticles include silica.

A number of implementations have been described. Nevertheless, it will be understood that various modifications may be made without departing from the spirit and scope of the disclosure. For example, combinations of the materials may be used. In some implementations, nanoparticles are added to the formulations shown as EI 1, EI 2, EI 3, or EI 4. Accordingly, other implementations are within the scope of the following claims.

1-31. (canceled)

32. A binder ink mixture for 3D printing of ceramic parts in a binder jet process, comprising a molecular space filler and a free radical initiator.

33. The binder ink mixture of claim 32, wherein the molecular space filler comprises a substituted polyhedral oligomeric silsesquioxane (POSS).

34. The binder ink mixture of claim 33, wherein the substituted polyhedral oligomeric silsesquioxane is substituted with 8 n-propyl acrylate groups (POSS-Ac₈), with a formula:

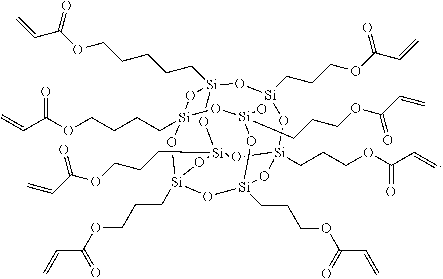 [SMILES: C=CC(=O)OCCCCC[Si]12O[Si]3(CCCCOC(=O)C=C)O[Si]4(CCCOC(=O)C=C)O[Si](CCCOC(=O)C=C)(O1)O[Si]1(CCCOC(=O)C=C)O[Si](CCCOC(=O)C=C)(O2)O[Si](CCCOC(=O)C=C)(O3)O[Si](CCCOC(=O)C=C)(O4)O1]

35. The binder ink mixture of claim 32, wherein the molecular space filler comprises a substituted polydimethylsiloxane.

36. The binder ink mixture of claim 35, wherein the substituted polydimethylsiloxane comprises a polymer of formula:

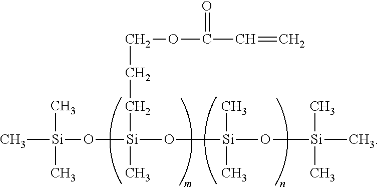

37. The binder ink mixture of claim 36, wherein m is between about 15 and about 20, and wherein the sum of m and n is 100.

38. The binder ink mixture of claim 32, further comprising a monomer.

39. The binder ink mixture of claim 38, wherein the monomer comprises 1,6-hexanediol diacrylate (HDDA), N,N-diethylacrylamide (DEAA), or isobornyl acrylate (IBXA), or any combinations thereof.

40. The binder ink mixture of claim 32, wherein the free radical initiator is a photoinitiator.

41. The binder ink mixture of claim 32, comprising nanoparticles.

42. The binder ink mixture of claim 41, wherein the nanoparticles comprise silica.

43. A method for making a binder ink mixture for forming ceramic parts in binder jet printing, comprising forming a blend of a molecular space filler and a free radical initiator.

44. The method of claim 43, wherein the molecular space filler comprises a substituted polyhedral oligomeric silsesquioxane (POSS), or a substituted polydimethylsiloxane, or both.

45. The method of claim 43, wherein the free radical initiator is a photoinitiator, or a thermal initiator, or both.

46. The method of claim 43, comprising blending a monomer into the binder ink mixture.

47. The method of claim 46, wherein the monomer comprises 1,6-hexanediol diacrylate (HDDA), N,N-diethylacrylamide (DEAA), or isobornyl acrylate (IBXA), or both.

48. A method of manufacturing a three-dimensional (3D) ceramic part using a binder ink mixture comprising a molecular space filler, comprising:
obtaining a binder ink mixture comprising a molecular space filler;
printing a green part, comprising:
printing a layer of the green part by:
forming a layer of ceramic beads in a binder jet printer;
printing a pattern of the binder ink mixture on the layer of ceramic beads; and
curing the binder ink mixture to bind the ceramic beads in the pattern in place; and
repeating the printing of layers of the green part until the green part is completed; and
sintering the green part to remove organic components of the binder ink mixture and fuse the ceramic beads to form the 3D ceramic part.

49. The method of claim 48, further comprising cleaning the green part prior to sintering to remove loose ceramic beads.

50. The method of claim 48, further comprising recycling loose ceramic beads to the binder jet printer.

51. The method of claim 48, wherein obtaining the binder ink mixture comprises forming a blend of the molecular space filler and a free radical initiator.
